(19) United States
(12) Patent Application Publication
(10) Pub. No.: US 2014/0131362 A1
(43) Pub. Date: May 15, 2014

(54) Pan Handle

(71) Applicant: ALLURE HOME CREATIONS CO., INC., Boonton, NJ (US)

(72) Inventors: Stanley Ho, Boonton, NJ (US); Emmanuel Lin, Taipei (TW); Kuo-Chieh Wang, Taipei (TW)

(73) Assignee: Allure Home Creations Co., Inc., Boonton, NJ (US)

(21) Appl. No.: 13/749,797

(22) Filed: Jan. 25, 2013

Related U.S. Application Data
(63) Continuation of application No. PCT/US2012/000552, filed on Nov. 13, 2012.

(51) Int. Cl. A47J 45/06

(52) U.S. Cl. CPC A47J 45/061
USPC 220/573.1

(57) ABSTRACT

The present invention relates to an improved and a novel pan handle for a pan. The pan comprises a pan body and a pan handle. The pan handle is disposed on the sidewall of the pan body, comprising a holding portion for a user to hold and a first projection portion disposed on the sidewall of the pan handle for the user's fingers to press against such that the user can move or turn the pan body angularly with the pan handle as the axis. When a user uses a pan according to the present invention, the user may hold the pan by means of the holding portion of the pan handle and exert force by pressing fingers against the first projection portion as a lever. As a result, the pan handle according to the present invention enables the user to exercise greater control of the pan and to exert less labor in handling the pan.

### BACKGROUND OF THE INVENTION

The present invention pertains to a novel pan handle and in particular a pan handle which enables the user to exercise greater control of the pan and to exert less labor in handling the pan.

Pans are one of the indispensable utensils for people to cook food. Regardless of pan types, people typically cook by placing food inside a pan, and then heating the food in the pan by means of a heating stove, such as a gas cook-top.

Pans typically have a pan body and a pan handle. The pan handle is disposed on the sidewall of the pan body, comprising a holding portion for a user to hold. The holding portion is designed in such a way that the user may use the handle to support the weight of the pan body and at the same time, can toss the pan body so as to turn over food inside the pan.

When the food in the pan is cooked, the user would typically use the holding portion as the axis and turn over the pan body to pour the food inside the pan body onto a plate. The pan body is often made of iron or aluminum materials or other materials with significant weight. With the added weight of the food inside the pan body, when a user is turning the pan body to pour the food, the burden on the user's wrist can be heavy, thereby making the pan difficult to control and causing possible injury with long term or over use. Accordingly, there is a need for a pan handle which will enable the user to exercise greater control of the pan and exert less labor in handling the pan. The pan handle according to the present invention achieves these objectives.

### SUMMARY OF THE INVENTION

The present invention comprises a pan body and a pan handle. The pan handle is disposed on the sidewall of the pan body. The pan handle according to the present invention comprises a holding portion for a user and a first projection portion disposed on the sidewall of the pan handle for the user's fingers to press against such that the user can move or turn the pan body angularly with the pan handle as the axis. When the user uses a pan according to the present invention, the user may hold the pan by means of the holding portion of the pan handle and exert force by pressing the thumb against the first projection portion as a lever. As a result, the pan handle according to the present invention will enable the user to exercise greater control of the pan and to exert less labor in handling the pan.

### BRIEF DESCRIPTION OF THE DRAWINGS

FIG. 1 is a three-dimensional view of a preferred embodiment according to the present invention.

FIG. 2 is a top view of a preferred embodiment according to the present invention.

FIG. 3 is an illustration of a preferred embodiment according to the present invention.

FIG. 4 is a second illustration of a preferred embodiment according to the present invention.

FIG. 5 is a third illustration of a preferred embodiment according to the present invention.

### DETAILED DESCRIPTION OF THE PREFERRED EMBODIMENTS

Characteristics and functions of the present invention will be described below in detail with reference to the accompanying drawings and embodiments such that the technology and structure of the present invention for attaining the above objects can be understood.

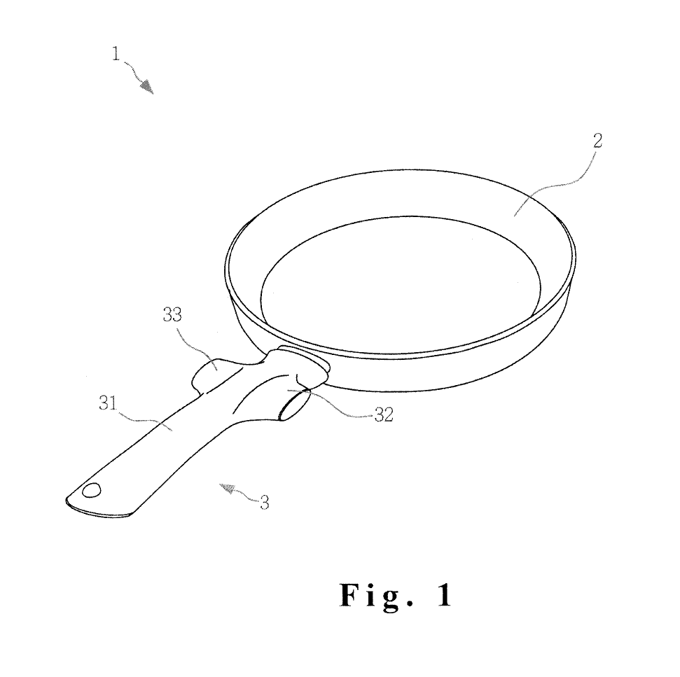

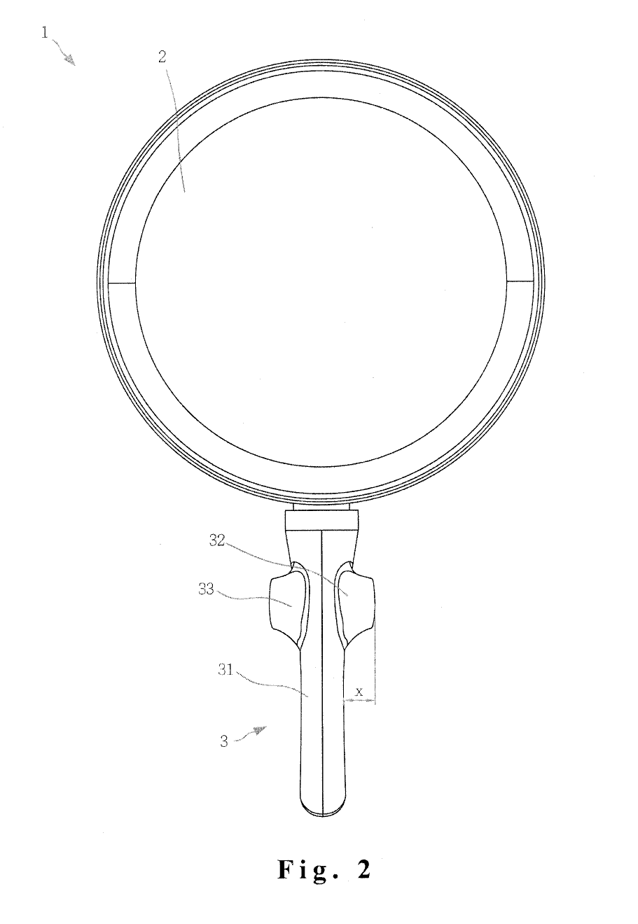

FIG. 1 and FIG. 2 are 3-dimensitonal view and top view of a preferred embodiment of the present invention, respectively. It can be seen from the figures that a pan 1 according to the present invention comprises a pan body 2. In this particular embodiment, the pan body 2 is a saucepan. The pan body according to the present invention, however, is not limited to a saucepan. It can be, for example, a pan with a curved bottom.

A pan handle 3 is disposed on the sidewall of said pan body 2, comprising a holding portion 31 and a first projection portion 32. The holding portion 31 is for a user to hold. The holding portion 31 is preferably formed with anti-slipping patterns such that the user holds the holding portion 31 to support the weight of the pan body 2. The first projection portion 32 is disposed on the sidewall of the pan handle 3 between the pan body 2 and the holding portion 31 for the user's fingers to press against such that the user can move or turn the pan body 2 angularly with the pan handle 3 as the axis. A preferable operation mode is to make angular movements by pressing the first projection portion 32 with the user's thumb. In the present embodiment, if the pan handle 3 is divided into two equal parts, then the first projection portion 32 is disposed on the part closer to the pan body 2.

In a preferred embodiment, a second projection portion 33 is further disposed on the sidewall of said pan handle 3 opposite to the first projection portion 32. The second projection portion 33 is disposed between the pan body 2 and the holding portion 31 for the user's index finger to press against such that the user can move or turn the pan body 2 angularly with the pan handle 3 as the axis. The second projection portion 33 is not a required component. The objectives of the present invention can be achieved without the second projection portion 33.

In a preferred embodiment, as shown in FIG. 2, there is a projection distance x between the side edge of the holding portion 31 and the side edge of the first projection portion 32, and the length of the projection distance x is between about 0.7 cm and about 10 cm; specifically, the length of the projection distance x can be between about 0.8, 1, 1.2, 1.4, 1.6, 1.8 or 2.0 cm and about 10 cm. As shown in FIG. 2, the distance x is calculated with the pan surface of the pan body 2 facing upward. Similarly, the second projection portion 33 may be disposed in the same symmetrical manner. However, it is not necessary that that the first and second projection portions 31 and 33 be disposed in a symmetrical manner. For example, the projection distance x for the first projection portion 31 does not have to be the same as the projection distance x for the second projection portion 33.

In another preferred embodiment, the first and/or second projection is extendable from an original position to one or more extended positions to accommodate users with larger hands or longer fingers. The projection is extendable by, for example, a telescopic mechanism.

In a further preferred embodiment, the first and/or second projection is slidable or movable along the pan handle from an original position to one or more set positions along the handle.

In another preferred embodiment, the pan handle comprises a splash guard located between the first and/or second projection and the pan body.

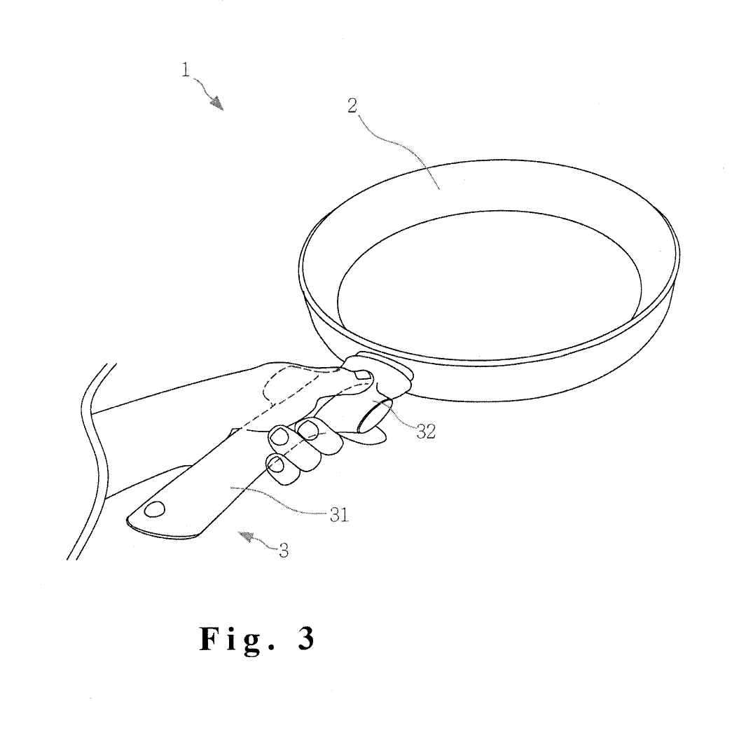

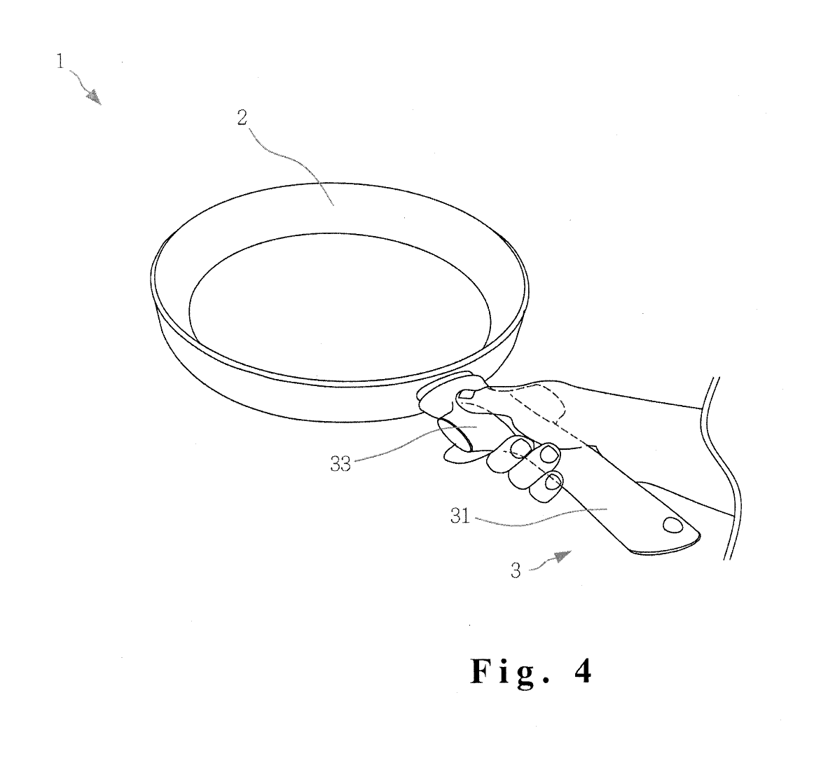

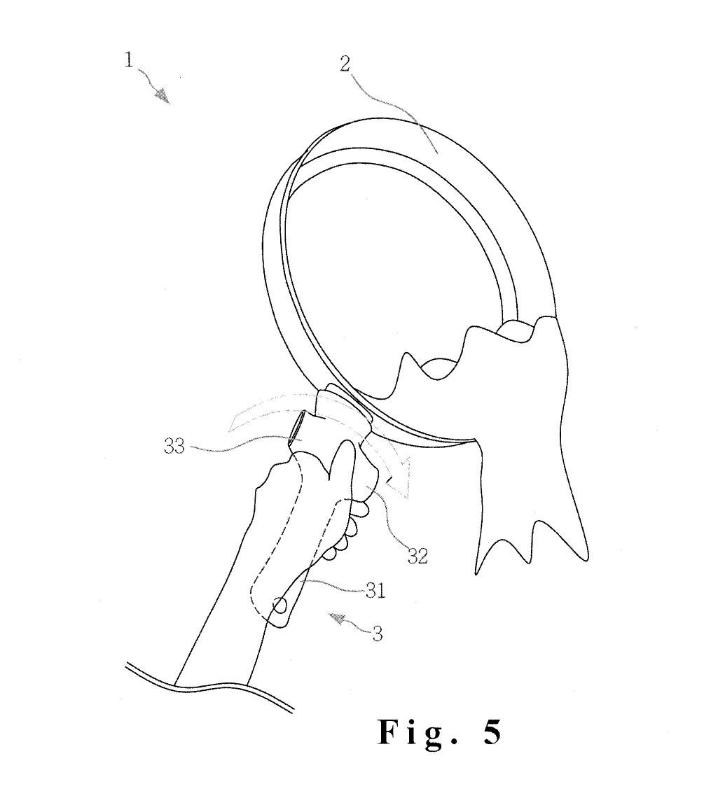

The operations of the present invention are described below with references to FIG. 3, FIG. 4 and FIG. 5. It can be seen from the figures that when a user uses the pan 1 according to the present invention, the user holds the pan 1 by means of the holding portion 31 of the pan handle 3 so as to support the weight of the pan body 2. In an embodiment, as shown in FIG. 3, the user uses the left hand to hold the holding portion 31; when the food inside the pan body 2 is cooked and the pan body 2 needs to be turned over to pour the food onto a dinner plate, the user may use the left thumb to press down the first projection portion 32 and then use the left index finger to press up the second projection portion 33. As a result, the user can easily move or turn pan body 2 angularly with the pan handle 3 as the axis.

When the user turns over the pan body 2 according to the above actions, the user uses the first projection portion 32 and the second projection portion 33 as levers to easily turn over the pan body 2. Moreover, the first projection portion 32 and the second projection portion 33 may also be disposed in ergonomic curves to facilitate the holding by thumbs and index fingers.

To facilitate the use by the public, moreover, as shown in FIG. 4, the present invention is not limited to left-handed or right-handed users. In case of a right-handed user, the user correspondingly uses the right thumb to press down the second projection portion 33 and then use the right index finger to press up the first projection portion 32. As a result, the user can easily move or turn the pan body 2 angularly with the pan handle 3 as the axis. Furthermore, the lengths of the first projection portion 32 and the second projection portion 33 can be specially designed. Generally, the longer the levers (the first projection portion 32 and the second projection portion 33) are, the easier the pan body 2 is made to rotate around the pan handle 3 as the axis.

Although this invention has been described with respect to specific embodiments, the details hereof are exemplary and are not to be construed as limitations.

1. A pan, comprising:
a pan body having a sidewall; and
an elongated pan handle disposed on and extending from the sidewall of said pan body, comprising (i) a holding portion and (ii) a first projection portion disposed on and projecting laterally from a sidewall of said pan handle, such that said pan body can be made to move angularly with said pan handle as the axis;
wherein said first projection is extendable from an original position projecting laterally from the sidewall by an original projection distance between a side edge of said holding portion and a side edge of said first projection portion to one or more extended positions projecting laterally from the sidewall by one or more corresponding projection distances between the side edge of said holding portion and the side edge of said first projection portion.

2. The pan of claim 1, wherein said first projection portion is disposed on the sidewall of the pan handle between the pan body and the holding portion.

3. The pan of claim 2, wherein said first projection is movable to one or more set positions along the pan handle.

4. The pan of claim 1, wherein a second projection portion is further disposed on and projecting laterally from the sidewall of said pan handle opposite to the position of said first projection portion.

5. The pan of claim 4, wherein said second projection is extendable from an original position projecting laterally from the sidewall by an original projection distance between a side edge of said holding portion and a side edge of said second projection portion to one or more extended positions projecting laterally from the sidewall by one or more corresponding projection distances between the side edge of said holding portion and the side edge of said second projection portion.

6. The pan of claim 5, wherein said second projection portion is disposed on the sidewall of the pan handle between the pan body and the holding portion.

7. The pan of claim 6, wherein said second projection is movable to one or more set positions along the pan handle.

8. The pan of claim 1, wherein said pan handle comprises a splash guard disposed between the pan body and the first projection.

9. The pan of claim 1, wherein at least one of the projection distances between the side edge of said holding portion and the side edge of said first projection portion is between about 0.7 cm and about 10 cm.

10. The pan of claim 4, wherein at least one of the projection distances between the side edge of said holding portion and the side edge of said second projection portion is between about 0.7 cm and about 10 cm.
